(19) United States
(12) Patent Application Publication
(10) Pub. No.: US 2014/0154114 A1
(43) Pub. Date: Jun. 5, 2014

(54) SWITCHED RELUCTANCE MOTOR ASSEMBLY AND METHOD OF ASSEMBLING THE SAME

(71) Applicant: SAMSUNG ELECTRO-MECHANICS CO., LTD., Suwon (KR)

(72) Inventors: Jin Su Seok, Suwon (KR); Jin Wook Baek, Suwon (KR); Hyun Taek Ahn, Suwon (KR); Young Bok Yoon, Suwon (KR)

(73) Assignee: SAMSUNG ELECTRO-MECHANICS CO., LTD, Suwon (KR)

(21) Appl. No.: 13/794,648

(22) Filed: Mar. 11, 2013

(30) Foreign Application Priority Data
Nov. 30, 2012 (KR) 10-2012-0137852

(51) Int. Cl. F04D 29/60; H02K 7/04

(52) U.S. Cl. CPC F04D 29/60; H02K 7/04
USPC 417/410.1; 310/51; 29/888.02

(57) ABSTRACT

Disclosed herein are a switched reluctance motor assembly and a method of assembling the same. The switched reluctance motor assembly includes: a shaft forming the center of rotation of a motor; a rotor part rotatably coupled on the shaft; a balancing part installed on upper and lower surfaces of the rotor part; and an impeller part installed on the balancing part, wherein the balancing part and the impeller part are formed integrally with or directly coupled to each other to prevent generation of unbalance at the time of attaching the impeller part, thereby making it possible to promote stable rotation.

### CROSS REFERENCE TO RELATED APPLICATION

This application claims the benefit of Korean Patent Application No. 10-2012-0137852, filed on Nov. 30, 2012, entitled “Switched Reluctance Motor Assembly and Method of Assembling the Same”, which is hereby incorporated by reference in its entirety into this application.

### BACKGROUND OF THE INVENTION

1. Technical Field

The present invention relates to a switched reluctance motor assembly and a method of assembling the same.

2. Description of the Related Art

Generally, a switched reluctance motor (SRM) called an SR motor is a motor in which both of a stator and a rotor have a magnetic structure, which is a salient pole, the stator has a concentrated type coil wound therearound, and the rotor is configured only of an iron core without any type of excitation device (a winding or a permanent magnet), such that a competitive cost is excellent.

More specifically, the switched reluctance motor (SRM), which rotates a rotor using a reluctance torque according to a change in magnetic reluctance, has a low manufacturing cost, hardly requires maintenance, and has an almost permanent lifespan due to high reliability. The switched reluctance motor is configured to include: a stator part, which is a stator, including a stator yoke and a plurality of stator salient poles protruding from the stator yoke; and a rotor part, which is a rotor, including a rotor core and a plurality of rotor salient poles protruding from the rotor core so as to face the stator salient poles and rotatably received in the stator part.

Meanwhile, a balancing part includes the rotor part and is formed to enclose a shaft. The balancing part may be integrally molded and manufactured through injection molding so as to be filled in an annular rotor core of the rotor part. As a balancing method, a method of cutting a portion of the balancing part in order to maintain balance at the time of rotation of the motor is used. An impeller part may be stably rotated by the balancing part. Since the structure of the switched reluctance motor as described above has been well-known as disclosed in the following Patent Documents, a detailed description and illumination thereof will be omitted.

Meanwhile, in the switched reluctance motor according to the prior art, the impeller part is mounted through a bearing mounted at the balancing part. In this configuration, a support part of the bearing is present only at one side, such that unbalance may occur at the time of attaching the impeller part. Therefore, sag occurs at a distal end of the shaft, such that stable rotation is difficult.

### PRIOR ART DOCUMENT

### Patent Document

(Patent Document 1) U.S. Pat. No. 4,011,624

(Patent Document 2) U.S. Pat. No. 4,920,608

(Patent Document 3) U.S. Pat. No. 6,125,498

### SUMMARY OF THE INVENTION

The present invention has been made in an effort to provide a switched reluctance motor assembly capable of promoting stable rotation by directly coupling an impeller part to a balancing part or forming the impeller part and the balancing part integrally with each other to prevent occurrence of unbalance at the time of attaching the impeller part, and a method of assembling the same.

According to a preferred embodiment of the present invention, there is provided a switched reluctance motor assembly including: a shaft forming the center of rotation of a motor; a rotor part rotatably coupled on the shaft; a balancing part installed on upper and lower surfaces of the rotor part; and an impeller part installed on the balancing part, wherein the balancing part and the impeller part are formed integrally with each other.

According to another preferred embodiment of the present invention, there is provided a switched reluctance motor assembly including: a shaft forming the center of rotation of a motor; a rotor part rotatably coupled on the shaft; a balancing part installed on upper and lower surfaces of the rotor part; and an impeller part coupled to the balancing part.

The switched reluctance motor assembly may further include: coupling protrusions protruding on an upper surface of the balancing part; and coupling grooves formed in a lower surface of the impeller part and having the coupling protrusions inserted thereinto.

The switched reluctance motor assembly may further include: coupling pieces protruding on an upper surface of the balancing part; and coupling grooves formed in a lower surface of the impeller part and having the coupling pieces inserted thereinto, wherein the coupling piece is formed in a “U” shape and includes an elastic deformation plate of which an opened upper surface is directed toward the lower surface of the impeller part and catching protrusions protruding on an outer side of the elastic deformation plate.

The switched reluctance motor assembly may further include: insertion grooves grooved in an upper surface of the balancing part; through-holes formed in a lower surface of the impeller part; and fixtures penetrating through the through-holes and then fixed to the insertion grooves.

The coupling groove may include a large diameter part into which the coupling protrusion is inserted and a small diameter part extended from the large diameter part and having a diameter smaller than that of the large diameter part, wherein the large diameter part and the small diameter part are continuously formed in a movement direction of the coupling protrusion.

The balancing part may include an upper balancing part positioned on the upper surface of the rotor part and a lower balancing part positioned on the lower surface of the rotor part.

The switched reluctance motor assembly may further include: a housing part enclosing an outer side of the rotor part; a diffuser part installed on a lower surface of the impeller part in the housing part; a cover part coupled to an upper portion of the housing part in an axial direction; an upper bearing positioned over the impeller part and installed on an inner surface of an upper portion of the cover part to support an upper end portion of the shaft; and a lower bearing installed on a lower surface of a lower balancing part to support a lower end portion of the shaft.

The rotor part may include an annular rotor core and a plurality of rotor poles protruding outwardly from the rotor core.

The switched reluctance motor assembly may further include a stator part receiving the rotor part therein, wherein the stator part includes a stator yoke receiving the rotor part therein and stator poles formed so as to correspond to the rotor poles and be spaced from the rotor poles and protruding inwardly of the stator yoke.

According to still another preferred embodiment of the present invention, there is provided a method of assembling a switched reluctance motor assembly, the method including: assembling a rotor assembly including a shaft forming the center of rotation of a motor, a rotor part rotatably coupled on the shaft, and a balancing part installed on upper and lower surfaces of the rotor part and having coupling protrusions protruding on the upper surface thereof; installing an impeller part on the balancing part of the rotor assembly and mounting the coupling protrusions of the balancing part into coupling grooves of the impeller part; installing the rotor assembly in which the impeller part is installed in a housing part in which a diffuser part is mounted; and installing a cover part on the housing part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional perspective view of a switched reluctance motor assembly according to a preferred embodiment of the present invention;

FIG. 2 is a partial cross-sectional view showing an example in which a balancing part and an impeller part according to the preferred embodiment of the present invention are directly coupled to each other;

FIG. 3 is a partial cross-sectional view showing another example in which a balancing part and an impeller part according to the preferred embodiment of the present invention are directly coupled to each other;

FIG. 4 is a partial cross-sectional view showing still another example in which a balancing part and an impeller part according to the preferred embodiment of the present invention are directly coupled to each other;

FIG. 5 is a perspective view showing that a core assembly according to the preferred embodiment of the present invention is assembled;

FIG. 6 is a perspective view showing that the core assembly and the impeller part according to the preferred embodiment of the present invention are directly coupled and assembled to each other;

FIGS. 7 and 8 are partial cross-sectional perspective views showing that a diffuser part and a housing part are assembled to the core assembly and the impeller part; and

FIG. 9 is a conceptual diagram showing a rotor part and a stator part according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A switched reluctance motor assembly according to a preferred embodiment of the present invention may be configured to include a shaft 10 forming the center of rotation of a motor, a rotor part 20 rotatably coupled on the shaft 10, a balancing part 40 installed on upper and lower surfaces of the rotor part 20, and an impeller part 80 installed on the balancing part 40, as described above. However, in the preferred embodiment of the present invention, the balancing part 40 and the impeller part 80 are formed integrally with each other or the impeller part 80 is directly coupled to the balancing part 40.

According to the prior art, as described above, the balancing part and the impeller part are indirectly coupled to each other through a bearing. In this configuration, a support part of the bearing is present only at one side, such that unbalance may occur at the time of attaching to the impeller part. Therefore, sag occurs at a distal end of the shaft, such that stable rotation is difficult.

In the present invention that is to solve the problem according to the prior art as described above, the balancing part is formed integrally with the balancing part or is directly coupled to the impeller part rather than through the bearing, such that the unbalance problem that has occurred in the prior art does not occur, thereby making it possible to implement more stable rotation.

In addition, since the balancing part 40 and the impeller part 80 are formed integrally with each other or are directly coupled to each other as described above, a slip of the impeller part that has occurred in the prior art does not occur.

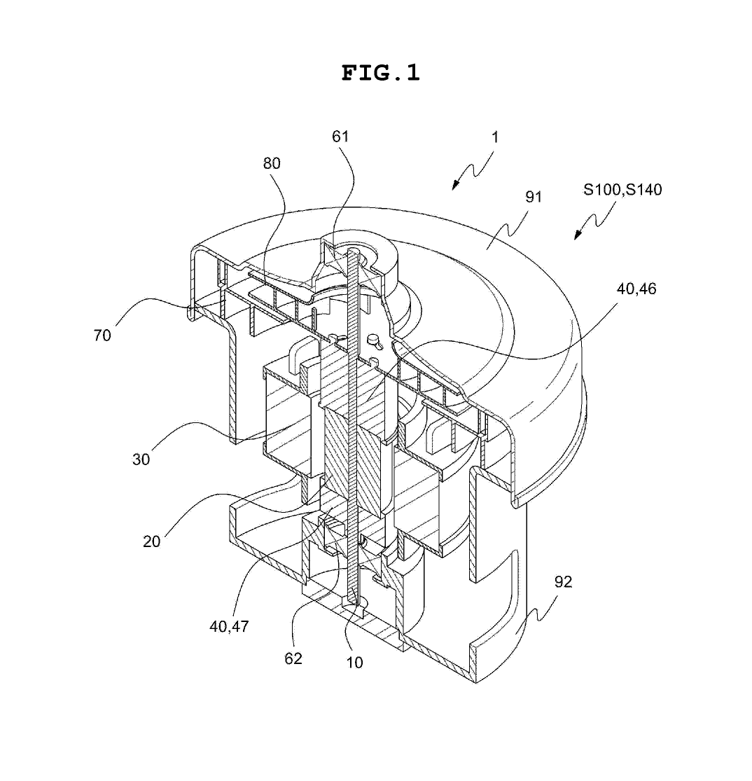

Meanwhile, in order to form the balancing part 40 integrally with the impeller part 80 according to the preferred embodiment of the present invention, a method of injection-molding the balancing part 40 integrally with the impeller part 80 at the time of molding the impeller part 80 may be used. In addition, in order to directly couple the impeller part 80 and the balancing part 40 to each other, a configuration as shown in FIGS. 1 to 5 may be used, which will be described below in detail.

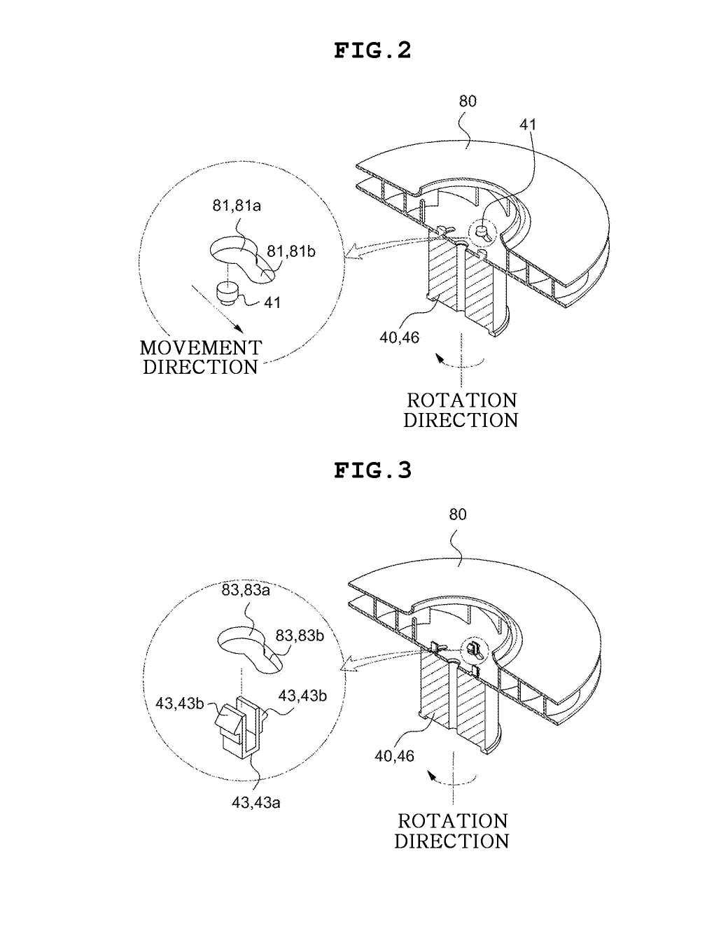

First, as shown in FIGS. 1 and 2, the switched reluctance motor assembly according to the preferred embodiment of the present invention includes coupling protrusions 41 protruding on an upper surface of the balancing part 40 and coupling grooves 81 formed in a lower surface of the impeller part 80 and having the coupling protrusions 41 inserted thereinto, thereby making it possible to directly couple the balancing part 40 and the impeller part 80 to each other. That is, when the impeller part 80 is mounted on the balancing part 40 on which the coupling protrusions 41 protrude, the coupling protrusions 41 penetrate through the coupling grooves 81, such that the balancing part 40 and the impeller part 80 are directly coupled to each other.

Here, the coupling groove 81 may include a large diameter part 81a into which the coupling protrusion 41 is inserted and a small diameter part 81b extended from the large diameter part 81a and having a diameter smaller than that of the large diameter part 81a as shown in FIG. 2, wherein the large diameter part 81a and the small diameter part 81a may be continuously formed in a movement direction of the coupling protrusion 41.

For example, as shown in FIG. 2, in the case in which a rotation direction of the balancing part 40 is a clockwise direction, a movement direction of the coupling protrusion 41 may be a right direction of FIG. 2. In this case, the small diameter part 81b of the coupling groove 81 may be formed at the right of the large diameter part 81a. In this configuration, when the balancing part 40 is rotated in a state in which the coupling protrusion 41 is inserted into the large diameter part 81a, since the impeller part 80 is instantaneously still and the balancing part 40 is rotated, the coupling protrusion 41 enters the small diameter 81b, such that fixing may be more firmly made.

Meanwhile, although the coupling protrusion 41 may have a cylindrical shape as shown and the coupling groove 81 may have a generally oval shape in which the large diameter part 81a and the smaller diameter part 81b are continuously formed, this is only an example for describing the present invention. That is, the coupling protrusion 41 and the coupling groove 81 may have other shapes as long as the coupling protrusion 41 may pass through the coupling groove 81 and be fixed thereto as described above, which may be included in the scope of the present invention.

In addition, although each of the numbers of coupling protrusion 41 and coupling grooves 81 may be four as shown, this is also only an example for describing the present invention. That is, each of the numbers of coupling protrusion 41 and coupling grooves 81 in the present invention is not limited thereto.

Although a configuration in which the coupling protrusions 41 protrude on the balancing part 40 is shown in FIGS. 1 and 2, a configuration in which the coupling protrusions protrude on the lower surface of the impeller part 80 and the coupling grooves into which the coupling protrusions are inserted are grooved in the upper surface of the balancing part 40 may also be possible.

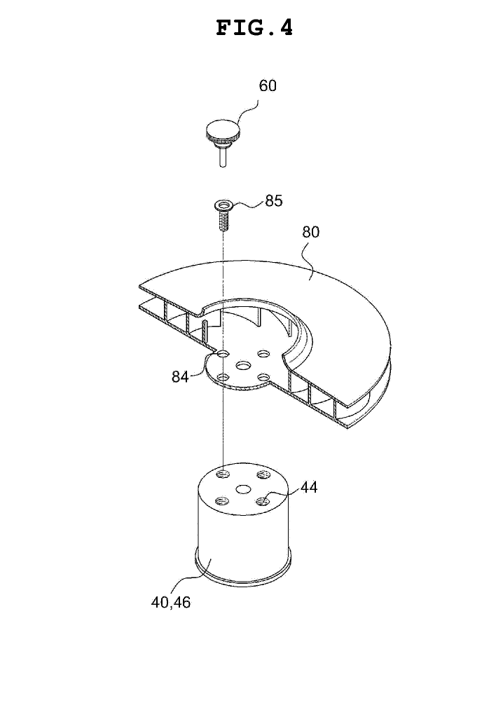

Meanwhile, in order to directly couple the balancing part 40 and the impeller part 80 to each other, the switched reluctance motor assembly according to the preferred embodiment of the present invention may include coupling pieces 43 protruding on the upper surface of the balancing part 40 and coupling grooves 83 formed in the lower surface of the impeller part 80 and having the coupling pieces 43 inserted thereinto, as shown in FIG. 3 Here, the coupling piece 43 may be formed in a “U” shape and include an elastic deformation plate 43a of which an opened upper surface is directed toward the lower surface of the impeller part 80 and catching protrusions 43b protruding on an outer side of the elastic deformation plate 43a.

That is, the coupling piece 43 includes the elastic deformation plate 43a that becomes wider or narrower by external force and returns to its original shape by elasticity and the catching protrusion 43b protruding on the outer side of the elastic deformation plate 43a to thereby be caught in the coupling groove 83. Here, the catching protrusion 43b may have an arrow shape in which an upper portion thereof is sharp as shown. In addition, the coupling groove 83 may include a large diameter part 83a and a small diameter part 83b, which are the same as the large diameter part 81a and the smaller diameter part 81b as described above. Therefore, an overlapped description will be omitted.

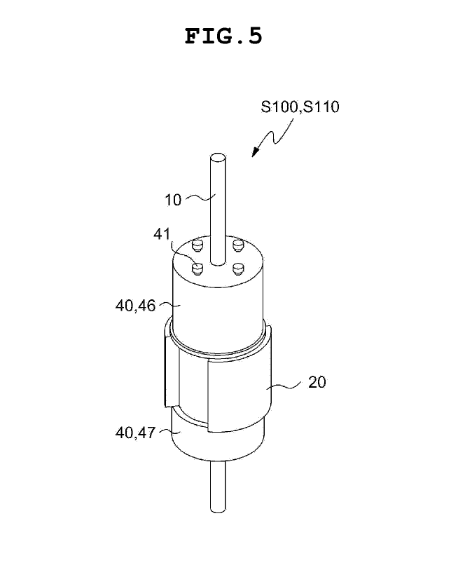

Meanwhile, as shown in FIG. 4, the switched reluctance motor assembly according to the preferred embodiment of the present invention includes insertion grooves 44 grooved in the upper surface of the balancing part 40, through-holes 84 formed in the lower surface of the impeller part 80, and fixtures 85 penetrating through the through-holes 84 and then fixed to the insertion grooves 44, thereby making it possible to directly couple the balancing part 40 and the impeller part 80 to each other. That is, unlike the case described above, the fixture 85 is installed in the through-hole 84 and the insertion groove 44, thereby directly coupling the balancing part 40 and the impeller part 80 to each other.

Meanwhile, as the fixture 85, a bolt as shown may be used. In this case, a screw thread may be formed an inner side of the insertion groove 44. Further, in order to more easily rotate the fixture 85, a rotating tool 60 may be used. Here, an example of the rotating tool 60 may include an electric motor.

Meanwhile, the balancing part 40 may include an upper balancing part 46 positioned on the upper surface of the rotor part 20 and a lower balancing part 47 positioned on the lower surface of the rotor part 20. In this configuration, the impeller part 80 may be formed integrally with or be directly coupled to the upper balancing part 46.

In addition, in this configuration, the shaft 10 may penetrate through the impeller part 80, the upper balancing part 46, the rotor part 20, and the lower balancing part 47 and have an upper bearing 61 and a lower bearing 62 formed at upper and lower edges thereof, respectively.

That is, the upper bearing 61 is positioned over the impeller part 80 and is installed on an inner surface of an upper portion of a cover part 92 to support an upper end portion of the shaft 10, and the lower bearing 62 is installed on a lower surface of the lower balancing part 47 to support a lower end portion of the shaft 10, thereby making it possible to prevent the occurrence of unbalance at the time of attaching the impeller part 80.

According to the prior art, as described above, the balancing part and the impeller part are indirectly coupled to each other through the bearing, such that the unbalance may occur at the time of attaching the impeller part. Therefore, sag occurs at a distal end of the shaft, such that stable rotation is difficult.

In the present invention that is to solve the problem according to the prior art as described above, the balancing part is formed integrally with the impeller part or is directly coupled to the impeller part rather than through the bearing, and the bearings are installed at the upper and lower edges of the shaft 10, respectively, such that the unbalance problem that has occurred in the prior art does not occur, thereby making it possible to implement more stable rotation.

As shown in FIG. 1, the switched reluctance motor assembly 1 according to the preferred embodiment of the present invention may include a housing part 92 enclosing an outer side of the rotor part 20, a diffuser part 70 installed on a lower surface of the impeller part 80 in the housing part 92, and a cover part 91 coupled to an upper portion of the housing part 92 in an axial direction.

In addition, the switched reluctance motor assembly 1 according to the preferred embodiment of the present invention may include the upper bearing 61 positioned over the impeller part 80 and installed on the inner surface of the upper portion of the cover part 91 to support the upper end portion of the shaft 10 and the lower bearing 62 installed on the lower surface of the lower balancing part 47 to support the lower end portion of the shaft 10, as described above.

Meanwhile, the upper bearing 61, which rotates the rotor part 20 while supporting self-weight of the shaft 10 in the axial direction as well as the rotating rotor part 20 and load applied to the shaft 10, may be installed on the inner surface of the upper portion of the cover part 91.

The diffuser part 70 allows pressure of air sucked in by the impeller part 80 to rise. The air of which the pressure rises is supplied through a space formed between an inner peripheral surface of the housing part 92 and an outer peripheral surface of the diffuser part 70, is guided to a central portion, and is then blown from the motor, such that the air is discharged while cooling the motor.

The housing part 92 is formed at outer sides of the rotor part 20, the balancing part 40, and the like, so as to be spaced apart from the rotor part 20, the balancing part 40, and the like, and to enclose the rotor part 20, the balancing part 40, and the like. The housing part 92 structurally protects components received therein, such as the rotor part 20, the stator part 30, and the like, and prevents other foreign materials from being introduced from the outside thereinto, thereby making it possible to improve reliability in an operation of the motor.

The cover part 91 is coupled to the upper portion of the housing part 92 in the axial direction, as shown in FIG. 1. Here, the cover part 91 coupled to the impeller part 80 serves to cover the upper portion of the housing part 92 and at the same time, adjusts an upper coupling height of the impeller part 80, thereby making it possible to improve efficiency of the motor. To this end, an outer edge of the housing part 92 is provided with a step part (not shown), thereby making it possible to improve reliability of a coupling height at the time of coupling between the cover part 91 and the housing part 92.

Meanwhile, the switched reluctance motor according to the prior art has a configuration in which a front part is coupled to the upper surface of the housing part 92, the diffuser part and the impeller part are installed on the front part, and the upper bearing is installed between the front part and the balancing part.

However, in the preferred embodiment of the present invention, since the balancing part 40 and the impeller part 80 are directly coupled to each other as described above and the upper bearing 61 is installed over the impeller part 80 shown, the front part that has been used in the prior art may be omitted.

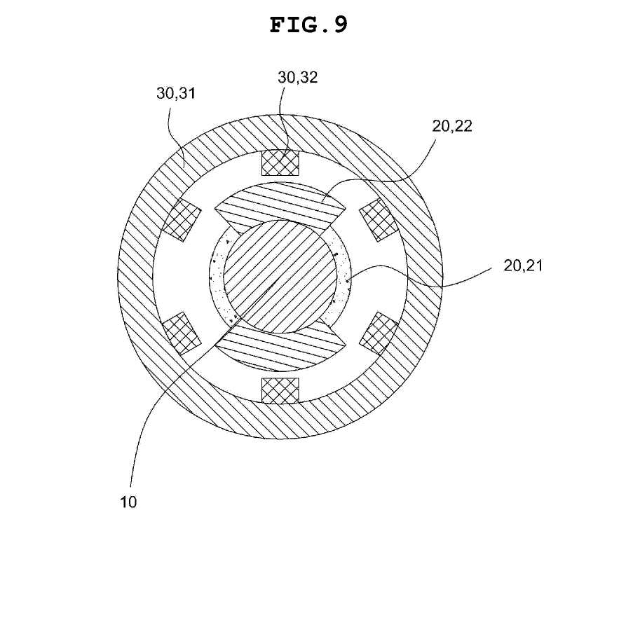

As shown in FIG. 9, the rotor part 20 may include an annular rotor core 21 and a plurality of rotor poles 22 protruding outwardly from the rotor core 21. Here, the rotor core 21 has a hollow hole formed at a central portion thereof, and the shaft 10 is fixedly coupled to the hollow hole to transfer rotation of the rotor part 20 to the outside. The plurality of rotor poles 22 may be formed to protrude outwardly along an outer circumferential surface of the rotor core 21 and be formed to correspond to stator poles 32 to be described below.

Meanwhile, the stator part 30 may include a stator yoke 31 and stator poles 32 as shown. The stator yoke 31 may include a hollow hole formed therein so as to receive the rotor part 20 therein, and a plurality of stator poles 32 may be formed to protrude from an inner surface of the stator yoke 31 and correspond to the rotor poles 22 of the rotor part 20. Here, a current is applied to the stator poles 32 of the stator yoke 31 to form a magnetic flux path through the stator poles 32 and the rotor poles 22 of the rotor part 20 facing the stator poles 32, such that the rotor part 20 rotates.

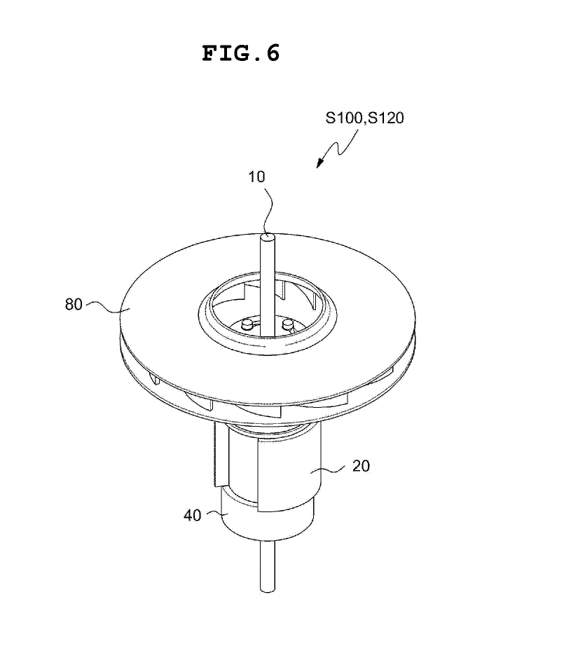

Hereinafter, a method (S100) of assembling a switched reluctance motor assembly 1 according to the preferred embodiment of the present invention will be described with reference to FIGS. 5 to 8.

First, a step (S110) (hereinafter, referred to a first step) of assembling a rotor assembly including the shaft 10 forming the center of rotation of a motor, the rotor part 20 rotatably coupled on the shaft 10, and the balancing part 40 installed on the upper and lower surfaces of the rotor part 20 and having the coupling protrusions 41 protruding on the upper surface thereof is performed, as shown in FIG. 5.

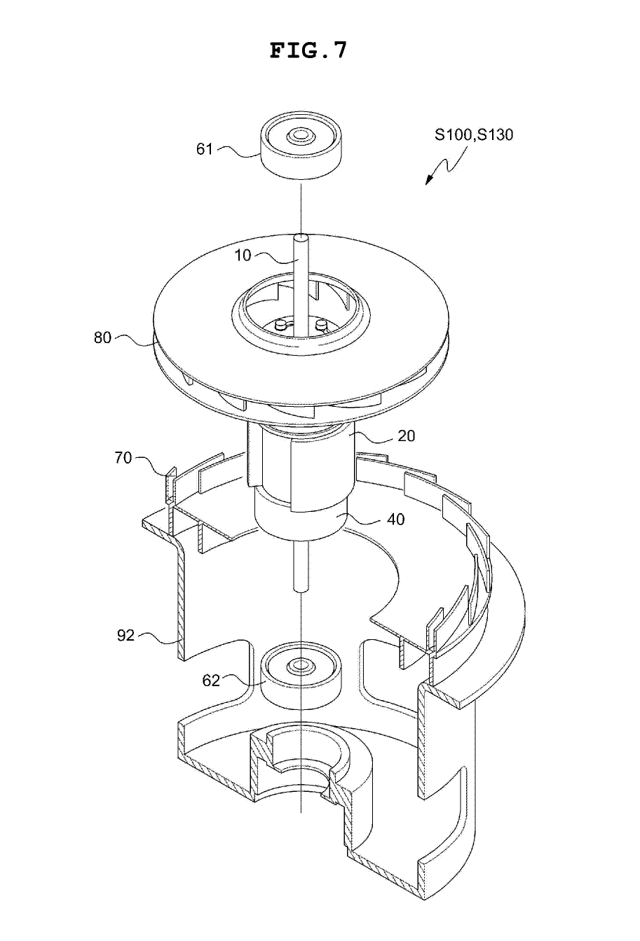

After the first step (S110) is performed, a step (S120) (hereinafter, referred to as a second step) of installing the impeller part 80 on the balancing part 40 of the rotor assembly and mounting the coupling protrusions 41 of the balancing part 40 into the coupling grooves 81 of to the impeller part 81 is performed, as shown in FIG. 6.

In this case, since the balancing part 40 and the impeller part 80 are directly coupled to each other in the second step (S120), the unbalance does not occur at the time of mounting the impeller part 80, thereby making it possible to promote stable rotation. In addition, the impeller part 80 and the balancing part 40 are directly coupled to each other, thereby making it possible to prevent slip of the impeller part 80, and the diffuser part 70 is directly coupled to the housing part 92, thereby making it possible to omit the front part as described above.

Meanwhile, although the case in which the balancing part 40 and the impeller part 80 are directly coupled to each other by the coupling protrusions 41 protruding on the upper surface of the balancing part 40 and the coupling grooves 81 formed in the lower surface of the impeller part 80 is shown in FIGS. 5 and 6, the present invention is not limited thereto. That is, the balancing part 40 and the impeller part 80 may also be directly coupled to each other by coupling the coupling protrusions 82 protruding on the lower surface of the impeller part 80 into the coupling grooves 42 grooved in the upper surface of the balancing part 40, as shown in FIG. 3. In addition, in order to directly couple the balancing part 40 and the impeller part 80 to each other, as shown in FIG. 4, the switched reluctance motor assembly according to the preferred embodiment of the present invention may include the coupling pieces 43 protruding on the upper surface of the balancing part 40 and the coupling grooves 83 formed in the lower surface of the impeller part 80 and having the coupling pieces 43 inserted thereinto. Here, the coupling piece 43 may be formed in a “U” shape and include an elastic deformation plate 43a of which an opened upper surface is directed toward the lower surface of the impeller part 80 and a catching protrusions 43b protruding on an outer side of the elastic deformation plate 43a.

Further, the switched reluctance motor assembly according to the preferred embodiment of the present invention includes the insertion grooves 44 grooved in the upper surface of the balancing part 40, the through-holes 84 formed in the lower surface of the impeller part 80, and the fixtures 85 penetrating through the through-holes 84 and then fixed to the insertion grooves 44, thereby making it possible to directly couple the balancing part 40 and the impeller part 80 to each other.

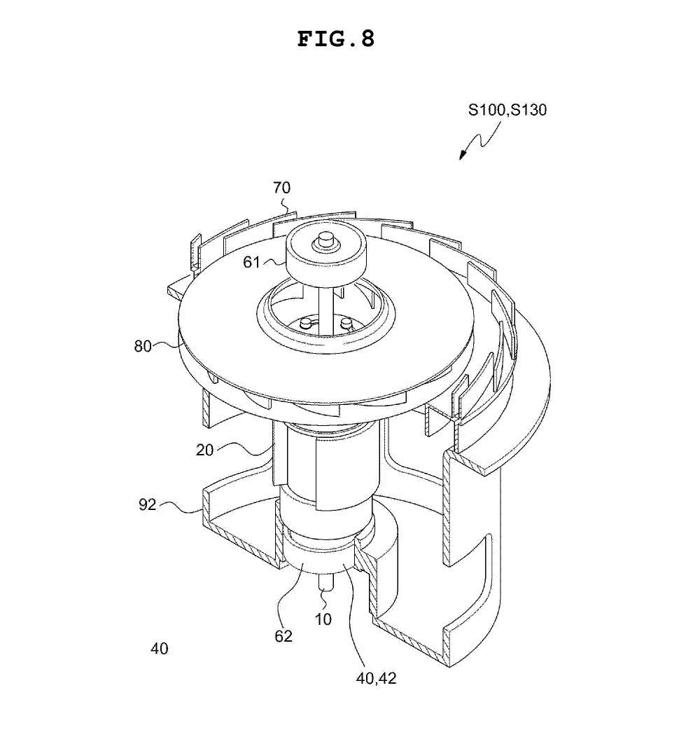

After the second step (S120) is performed, a step (S130) (hereinafter, referred to as a third step) of installing the rotor assembly in which the impeller part 80 is installed in the housing part 92 in which the diffuser part 70 is mounted is performed as shown in FIGS. 7 and 8.

As shown, in the third step (S130), since the upper bearing 61 is installed over the impeller part 80 and the diffuser part 70 is directly installed in the housing part 92, the front part according to the prior art is not required.

After the third step (S130) is performed, a step (S140) (hereinafter, referred to as a fourth step) of installing the cover part 91 on the housing part 92 is performed as shown in FIG. 1.

In the fourth step (S140), the upper bearing 61 is installed over the impeller part 80 as described above.

As set forth above, according to the preferred embodiments of the present invention, the impeller part and the balancing part are formed integrally with each other or are directly coupled to each other, such that the unbalance does not occur at the time of mounting the impeller part, thereby making it possible to promote the stable rotation. Therefore, efficiency of the switched reluctance motor assembly according to the preferred embodiment of the present invention may be improved.

In addition, the impeller part and the balancing part are formed integrally with each other or are directly coupled to each other, such that the slip of the impeller part may be prevent and the diffuser part may be directly coupled to the housing, thereby making it possible to omit the front part.

Further, the impeller part is coupled to the support part between the bearings disposed at both distal ends to maintain balance of force applied to the shaft, thereby making it possible to maintain the entire balance of the motor rotation.

Furthermore, the front part supporting the bearing is omitted, thereby making it possible to prevent an assembling error that may be generated at the time of coupling the front part for supporting the bearing and a distortion phenomenon of bearing concentricity that may be generated at the time of assembling in advance.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor assembly comprising:
a shaft forming the center of rotation of a motor;
a rotor part rotatably coupled on the shaft;
a balancing part installed on upper and lower surfaces of the rotor part; and
an impeller part installed on the balancing part,
wherein the balancing part and the impeller part are formed integrally with each other.

2. A switched reluctance motor assembly comprising:
a shaft forming the center of rotation of a motor;
a rotor part rotatably coupled on the shaft;
a balancing part installed on upper and lower surfaces of the rotor part; and
an impeller part coupled to the balancing part.

3. The switched reluctance motor assembly as set forth in claim 2, further comprising:
coupling protrusions protruding on an upper surface of the balancing part; and
coupling grooves formed in a lower surface of the impeller part and having the coupling protrusions inserted thereinto.

4. The switched reluctance motor assembly as set forth in claim 2, further comprising:
coupling pieces protruding on an upper surface of the balancing part; and
coupling grooves formed in a lower surface of the impeller part and having the coupling pieces inserted thereinto,
wherein the coupling piece is formed in a “U” shape and includes an elastic deformation plate of which an opened upper surface is directed toward the lower surface of the impeller part and catching protrusions protruding on an outer side of the elastic deformation plate.

5. The switched reluctance motor assembly as set forth in claim 2, further comprising:
insertion grooves grooved in an upper surface of the balancing part;
through-holes formed in a lower surface of the impeller part; and
fixtures penetrating through the through-holes and then fixed to the insertion grooves.

6. The switched reluctance motor assembly as set forth in claim 3, wherein the coupling groove includes a large diameter part into which the coupling protrusion is inserted and a small diameter part extended from the large diameter part and having a diameter smaller than that of the large diameter part,
the large diameter part and the small diameter part being continuously formed in a movement direction of the coupling protrusion.

7. The switched reluctance motor assembly as set forth in claim 1, wherein the balancing part includes an upper balancing part positioned on the upper surface of the rotor part and a lower balancing part positioned on the lower surface of the rotor part.

8. The switched reluctance motor assembly as set forth in claim 1, further comprising:
a housing part enclosing an outer side of the rotor part;
a diffuser part installed on a lower surface of the impeller part in the housing part;
a cover part coupled to an upper portion of the housing part in an axial direction;
an upper bearing positioned over the impeller part and installed on an inner surface of an upper portion of the cover part to support an upper end portion of the shaft; and
a lower bearing installed on a lower surface of a lower balancing part to support a lower end portion of the shaft.

9. The switched reluctance motor assembly as set forth in claim 1, wherein the rotor part includes an annular rotor core and a plurality of rotor poles protruding outwardly from the rotor core.

10. The switched reluctance motor assembly as set forth in claim 9, further comprising a stator part receiving the rotor part therein,
wherein the stator part includes a stator yoke receiving the rotor part therein and stator poles formed so as to correspond to the rotor poles and be spaced from the rotor poles and protruding inwardly of the stator yoke.

11. A method of assembling a switched reluctance motor assembly, the method comprising:
assembling a rotor assembly including a shaft forming the center of rotation of a motor, a rotor part rotatably coupled on the shaft, and a balancing part installed on upper and lower surfaces of the rotor part and having coupling protrusions protruding on the upper surface thereof;
installing an impeller part on the balancing part of the rotor assembly and mounting the coupling protrusions of the balancing part into coupling grooves of the impeller part;
installing the rotor assembly in which the impeller part is installed in a housing part in which a diffuser part is mounted; and
installing a cover part on the housing part.
